(19) United States
(12) Patent Application Publication
(10) Pub. No.: US 2026/0338676 A1
(43) Pub. Date: Oct. 29, 2026

(54) DEVICES, METHODS, AND SYSTEMS FOR MEASURING AND RECORDING A REACTANT ARRAY

(71) Applicant: SENSILL, INC., Concord, CA (US)

(72) Inventors: Yan Zhou, Pleasanton, CA (US); William Shea, Martinez, CA (US)

(73) Assignee: SENSILL, INC., Concord, CA (US)

(21) Appl. No.: 19/701,225

(22) Filed: Jun. 8, 2026

Related U.S. Application Data
(63) Continuation of application No. PCT/US2024/058796, filed on Dec. 6, 2024.
(60) Provisional application No. 63/607,926, filed on Dec. 8, 2023.
(60) Provisional application No. 63/607,936, filed on Dec. 8, 2023.
(60) Provisional application No. 63/621,024, filed on Jan. 15, 2024.
(60) Provisional application No. 63/656,306, filed on Jun. 5, 2024.
(60) Provisional application No. 63/656,311, filed on Jun. 5, 2024.
(60) Provisional application No. 63/656,320, filed on Jun. 5, 2024.

(51) Int. Cl. G01N 21/25; G01N 21/03; G01N 21/41

(52) U.S. Cl. CPC G01N 21/253; G01N 21/03; G01N 21/41; G01N 2021/0389; G01N 2201/0221

(57) ABSTRACT

Devices, systems, and methods may include or use a fixed imaging system with a window defining a window plane and an image sensor proximal of the window plane. The fixed imaging system may include or may be used with an optical relay positioned between the window plane and an object plane. The fixed imaging system may be configured to capture an image of an object at the object plane along an optical path through the window plane and the optical relay. The object may be a reactant array, which may be on a substrate. A housing may be configured to receive the substrate and position the reactant array at the object plane.

### CROSS REFERENCE TO RELATED APPLICATIONS

This application is a continuation of International Application No. PCT/US2024/058796, filed Dec. 6, 2024, which claims priority to U.S. Provisional Patent Application No. 63/607,926, filed Dec. 8, 2023; U.S. Provisional Patent Application No. 63/607,936, filed Dec. 8, 2023; U.S. Provisional Patent Application No. 63/621,024, filed Jan. 15, 2024; U.S. Provisional Patent Application No. 63/656,306, filed Jun. 5, 2024; U.S. Provisional Patent Application No. 63/656,311, filed Jun. 5, 2024; and U.S. Provisional Patent Application No. 63/656,320, filed Jun. 5, 2024. The disclosures of the foregoing applications are incorporated herein by reference in their entireties.

### TECHNICAL FIELD

The present disclosure pertains to sensing and analysis tools, and the like. More particularly, the present disclosure pertains to devices and systems for sensing and analyzing fluids, and methods for manufacturing and using such devices.

### BACKGROUND

A wide variety of devices have been developed for collection, storing, sensing, and analysis of samples. These devices are manufactured by any one of a variety of different manufacturing methods and may be used according to any one of a variety of methods. Of the known medical devices and methods, each has certain advantages and disadvantages.

### BRIEF SUMMARY

This disclosure provides design, material, manufacturing method, and use alternatives for sensing and analysis devices. Although it is noted that collection, storing, sensing, and analysis approaches and systems are known, there exists a need for improvement on those approaches and systems.

An example system may include a fixed imaging system having a window plane and an image sensor proximal of the window plane, wherein the fixed imaging system is configured to image an object at a plane distal of the window plane.

Alternatively or additionally to any of the embodiments in this section, the fixed imaging system may be a contact imaging system.

In another example, a system may include a fixed imaging system having a window defining a window plane and an image sensor proximal of the window plane and an optical relay positioned between the window plane and an object plane, wherein the fixed imaging system is configured to capture an image of an object at the object plane along an optical path through the window plane and the optical relay.

Alternatively or additionally to any of the embodiments in this section, the optical relay may be configured to relay the image of the object at the object plane to the window plane.

Alternatively or additionally to any of the embodiments in this section, the optical relay may comprise one or more lenticular arrays configured to relay the image of the object to the window plane.

Alternatively or additionally to any of the embodiments in this section, the one or more lenticular arrays comprises four stacked lenticular arrays forming a two-stage optical relay.

Alternatively or additionally to any of the embodiments in this section, the one or more lenticular arrays may comprise two upper lenticular arrays having refracting surfaces facing in a distal direction, toward the object plane and two lower lenticular arrays having refracting surfaces facing in a proximal direction, toward the window plane.

Alternatively or additionally to any of the embodiments in this section, the system may further include a prism array configured to redirect illumination light onto the object.

Alternatively or additionally to any of the embodiments in this section, the system may further include a slit array positioned between the window and the object plane.

Alternatively or additionally to any of the embodiments in this section, the optical relay may comprise a gradient or graded refractive index rod lens array.

Alternatively or additionally to any of the embodiments in this section, the window and the image sensor may be part of a contact imaging system.

Alternatively or additionally to any of the embodiments in this section, the image sensor may comprises a photodiode array.

In another example, a system may include a substrate comprising a reactant array, a fixed imaging system having a window defining a window plane and an image sensor proximal of the window plane, and a housing configured to receive the substrate and position the reactant array at an object plane distal of the window plane, and wherein the fixed imaging system is configured to image the reactant array.

Alternatively or additionally to any of the embodiments in this section, the reactant array may be a colorimetric sensor array.

Alternatively or additionally to any of the embodiments in this section, the fixed imaging system may comprise one or more illumination sources configured to illuminate the reactant array.

Alternatively or additionally to any of the embodiments in this section, the system may further include an optical relay positioned between the window plane and an object plane located at the reactant array.

Alternatively or additionally to any of the embodiments in this section, the optical relay may comprise a two-stage optical relay.

In another example, a method may include positioning a reactant array at an object plane spaced from and distal of a window plane of a fixed imaging system, the fixed imaging system comprises an image sensor proximal of the window plane and capturing an image of the reactant array with the image sensor along an optical path extending through the window plane and to the object plane.

Alternatively or additionally to any of the embodiments in this section, the method may include illuminating the reactant array with illumination light while imaging the reactant array.

Alternatively or additionally to any of the embodiments in this section, the method may include redirecting the illumination light using a prism array.

Alternatively or additionally to any of the embodiments in this section, the method may include relaying the image of the reactant array through an optical relay positioned between the window plane and the object plane.

Alternatively or additionally to any of the embodiments in this section, the optical relay may comprise a plurality of lenticular arrays or gradient/graded refractive index rod lens arrays configured to form a two-stage optical relay.

Alternatively or additionally to any of the embodiments in this section, positioning the reactant array at the object plane may comprise inserting a substrate comprising the reactant array in a housing.

The above summary of some embodiments is not intended to describe each disclosed embodiment or every implementation of the present disclosure. The Figures, and Detailed Description, which follow, more particularly exemplify these embodiments.

### BRIEF DESCRIPTION OF THE DRAWINGS

The disclosure may be more completely understood in consideration of the following detailed description in connection with the accompanying drawings, in which:

FIG. 1 is a schematic diagram of an illustrative analysis system;

FIG. 2 is a schematic diagram of an illustrative computing system;

FIG. 3 is a schematic diagram of an illustrative analysis system in a hand of a user;

FIG. 4 is a schematic cross-sectional diagram of an illustrative analysis system;

FIG. 5 is a schematic diagram of illustrative two stage optical relay configurations;

FIGS. 6A and 6B are schematic cross-sectional and side diagrams of an illustrative analysis system;

FIGS. 7A and 7B are schematic cross-sectional and side diagrams of an illustrative analysis system;

FIGS. 8A and 8B are schematic cross-sectional and side diagrams of an illustrative analysis system;

FIGS. 9A and 9B are schematic cross-sectional and side diagrams of an illustrative analysis system;

FIG. 10 is a schematic perspective view of an illustrative optical relay configuration for an analysis system;

FIGS. 11A and 11B are schematic cross-sectional and side diagrams of an illustrative analysis system;

FIG. 12 is a schematic diagram of an illustrative optical relay configuration for an analysis system; and

FIG. 13 is a schematic box diagram of an illustrative method of using an analysis system.

While the disclosure is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the disclosure.

### DETAILED DESCRIPTION

For the following defined terms, these definitions shall be applied, unless a different definition is given in the claims or elsewhere in this specification.

The term “fluid” is inclusive of both liquids and gases.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

It is noted that references in the specification to “a configuration”, “some configurations”, “other configurations”, etc., indicate that the configuration described may include one or more particular features, structures, and/or characteristics. However, such recitations do not necessarily mean that all configurations include the particular features, structures, and/or characteristics. Additionally, when particular features, structures, and/or characteristics are described in connection with one configuration, it should be understood that such features, structures, and/or characteristics may also be used in connection with other configurations whether or not explicitly described unless clearly stated to the contrary.

The following detailed description should be read with reference to the drawings in which similar structures in different drawings are numbered the same. The drawings, which are not necessarily to scale, depict illustrative embodiments and are not intended to limit the scope of the disclosure. Additionally, it should be noted that in any given figure, some features may not be shown, or may be shown schematically, for clarity and/or simplicity. Additional details regarding some components and/or method steps may be illustrated in other figures in greater detail. The devices and/or methods disclosed herein may provide a number of desirable features and benefits as described in more detail below.

Fluids with concentrations of volatile compounds (e.g., volatile organic compounds (VOCs)) and/or gasses, which may or may not be hazardous, may be sensed, analyzed, and/or monitored. Sensing, analyzing, and/or monitoring of fluids with analytes (e.g., non-volatile or volatile compounds, gases, liquids, and/or other fluids) may utilize images, light absorption, and/or light reflectance measurements of reactants exposed to such fluids for any purpose including, but not limited to, diagnostic hazard warning, manufacturing processes or quality control, record keeping, archival purposes, product development, product-consumer matching, etc.

In some cases, VOCs and/or gasses may be present in ambient fluid (e.g., ambient air, etc.) and sensed, analyzed, and/or monitored using reactants for real-time alarms, to treat subjects, or to collect and/or archive data for health records, regulatory compliance records, etc. Further, VOCs and/or gasses exhaled or emitted, excreted, emanated, released, and/or secreted from a subject (e.g., humans, animals other than humans, food, produce, meat, pathogens, bacteria (e.g., good and/or bad bacteria), plants, wounds, ulcers, surgical sites, skin of a subject, mouth of a subject, nasal passages of a subject, sinuses of a subject, rectum area of a subject, vaginal area of a subject, genitals area of a subject, ear canals of a subject, pores of a subject, etc.) may be sensed, analyzed, and/or monitored to assess hazardous, dangerous, or illegal substances in or at the subject or target site, a lung condition of lungs of a subject, a condition of a blood disease, a condition of infections, conditions related to diseases or biological conditions, conditions related to general health, conditions related to food flavors, conditions related to perfumes or smells, and/or other suitable conditions.

The systems discussed herein for sensing, analyzing, and/or monitoring fluids (e.g., for analytes of interest) may be configured to accurately detect and record a reactant array (e.g., a reactant array of or forming a colorimetric sensor array (CSA) or other suitable reactant array) response to exposure to the fluids. The systems may utilize techniques for non-invasively detecting one or more analytes of interest (e.g., one or more pathogens responsible for specific human skin infections including, but not limited to, skin infections, urinary tract infections (UTIs), vaginitis, wound infections, ulcers, etc., and/or other suitable analytes) from a fluid using a CSA to allow for early detection of and early implementation of protocols to address one or more conditions associated with any sensed analytes of interest. In one example, enhanced classification of one or more analytes using the systems described herein may enable detection and identification of responsible pathogens at the very beginning stages of a dangerous skin infection, which may result in a high level of protection and probability of a favorable outcome for subjects.

An analysis system (e.g., a CSA analysis system) may include a substrate containing or otherwise supporting a reactant array and a device for reading or otherwise analyzing the reactant array before, during, and/or after the reactant array is exposed to a fluid. The device for analyzing the reactant array (e.g., a reader device) may be or may include any suitable image or light collector/sensor. In some instances, the device may be configured to be handheld. Further, the device for analyzing the reactant array may be configured to be simple to use, minimize human error, reduce cross contamination of samples, and reduce human risk of exposure to analytes received at the device. In some examples, a fixed imaging device or system, such as contact imaging systems (CIS) and/or other suitable fixed imaging devices or systems, may be utilized to analyze the reactant array. Fixed imaging devices or systems may have a fixed object focal plane adjacent to the top surface of its clear cover (e.g., a window having a window plane at the top surface) and a relatively small dimensions (e.g., configured to be handheld).

In operation, the substrate containing a reactant array may be placed at a desired location relative to the device for analyzing the reactant array (e.g., into, onto, etc. the device) during and/or through pre and post exposure to fluid for optimal reactant array analysis. That is, analysis of the reactant array may include analyzing the reactant array prior to exposure to the fluid, during exposure to the fluid, and/or after exposure to the fluid is complete. Once the analysis of the reactant array is complete, the substrate may be removed from the device for analyzing the reactant array and discarded. Having the substrate be disposable may prevent cross-contaminations of the reactant array and erroneous analyses (e.g., due to the previous fluids persisting in the tubing and reflowing over the reactant array, undesirably flowing onto a human, etc.).

The substrate may be any suitable component including one or more reactant arrays and that may be configured to expose the one or more reactant arrays to fluids from a target area or site. In one example, the substrate may be a monolithic component having the reactant array thereon. In one example, the substrate may be or may be part a flow cell and may have an input port for receiving fluid (e.g., a fluid from a target area or site) to pass over and/or through the one or more reactant arrays and an output port for outputting the fluid passed through and/or over the one or more reactant arrays. In one example, the cartridge may be configured to receive a specimen including a sample from a target area or site. Example suitable substrates or flow cells include, but are not limited to those described in, PCT Application No. PCT/US23/83076, entitled DEVICES, METHODS, AND SYSTEMS FOR MEASURING AND RECORDING A REACTANT ARRAY, filed on Dec. 8, 2023, which is hereby incorporated by reference in its entirety for any and all purposes.

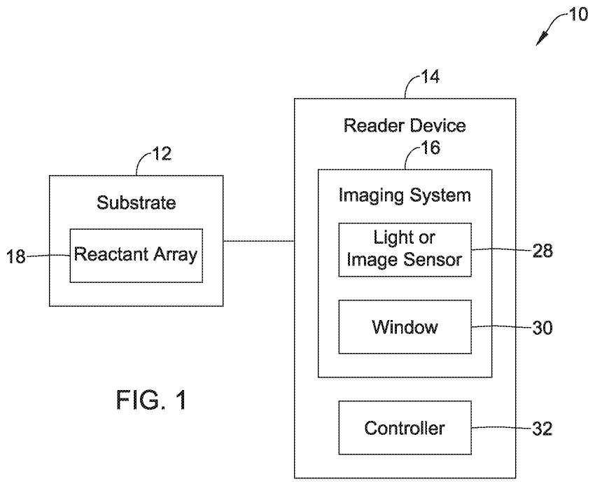

Turning to the Figures, FIG. 1 depicts a schematic diagram of an illustrative system 10 for analyzing a reactant array. Among other components the system 10 may include a substrate 12 having the reactant array 18 and a reader device 14 configured to monitor and/or analyze the reactant array 18.

The substrate 12 may have any suitable configuration and may include any suitable components configured to facilitate the reactant array 18 interacting with a fluid of interest. Example components of the substrate 12 include, but are not limited to, one or more reactant arrays 18, a support structure, a planar surface supporting the reactant array(s) 18, a non-planar surface supporting the reactant array(s) 18, a baffle, a standoff, one or more compartments, one or more locks, one or more specimen detectors, a housing, a window for viewing the reactant array 18, a blade, gasket, one or more access openings extending between the compartments and exterior of the housing, one or more valves configured to seal the access opening, one or more doors or lids, one or more pumps for pumping fluid of interest to the reactant array 18, one or more fluid paths or passages, one or more optical paths, tubing, one or more diaphragms or membranes, one or more single-use components, and/or other suitable components.

The substrate 12 may be formed from any suitable material. Example suitable materials for the substrate 12 include, but are not limited to, polymers, metals, glass, natural fibers, and/or other suitable types of materials.

The substrate 12 may have any suitable shape and/or size configured to support the reactant array 18 or facilitate exposing the reactant array 18 to a fluid of interest. For example, the substrate 12 may have a cube shape, an elongate shape, a rectangular shape, an oval shape, a rounded shape, a circular shape, a cup shape, a ball shape, and/or other suitable shape.

In some cases, the substrate 12 may be reusable. For example, in instances when the reactant array 18 and/or other components of the substrate 12 that may be spent or contaminated with a received fluid, the reactant array 18 and/or other spent or contaminated components of the substrate 12 may be removed from the substrate 12 and the remaining components of the substrate 12 may be reused after cleaning, as needed. In some cases, the reactant array 18 may include reversible reactant material and the reactant array 18 may be reused with other components of the substrate 12.

The reactant array 18 may be any suitable array of one or more reactants (e.g., analyte sensitive material) and the reactants of the reactant array 18 may be formed from any suitable material. In some examples, the reactant array 18 may be configured to be supported by or housed within the substrate 12. In some cases, the reactant array 18 may be part of or form a colorimetric sensor array (CSA), but other suitable configurations are contemplated. When the reactant array 18 forms or is otherwise part of a CSA, the substrate 12 may or may not be part of the CSA. Additionally or alternatively, the reactant array 18 may be formed by applying the material of the reactants to a planar or non-planar surface of the substrate 12.

The material of the reactants of the reactant array 18 may be reversible (e.g., reusable), semi-reversible, or non-reversible (e.g., single use). In some examples, the material of the reactants may be an optically responsive chemical material (e.g., a chemoresponsive material) that changes color in response to detecting one or more analytes (e.g., volatile compounds gasses, liquids, and/or other fluids) in a fluid to which the reactants are exposed, but other suitable material is contemplated. Example suitable materials for reactants include dyes from, but not limited to, the following classes: Lewis acid/base dyes (e.g., metal containing dyes), Brensted acidic or basic dyes (e.g., pH indicators), dyes with large permanent dipoles (e.g., solvatochromic dyes), redox responsive dyes (e.g., metal nanoparticle precursors), and/or other suitable classes of dyes. One example material for the reactants may be a silver nanoparticle material. Other suitable materials for the reactants are contemplated, including reactant material other than a printed dye or an optically responsive chemical material.

The reactants of the reactant array 18 may be applied to the substrate 12 in any suitable manner. In one example, the reactants may be applied to the substrate 12 by printing the reactants (e.g., the material of the reactants) on the substrate 12. When printed, any suitable printing techniques may be utilized including, but not limited to, pin transfer, inkjet, silkscreen, and/or other suitable application techniques.

The reactants of the reactant array 18 may be applied to the substrate 12 randomly and/or to form one or more patterns. Example configurations of the reactants of the reactant array 18 applied to the substrate 12 include, but are not limited to, continuous patterns, partition patterns, segmented patterns, partitioned patterns, segmented patterns, perforated patterns, dots, strips, grid patterns of rows and columns, concentric rings, color matching of a color of printed dye material with a color of a substrate material prior to interactions of the reactants with analyte, patterns that result in identifiable shapes when the analyte sensitive material reacts to a particular analyte, other suitable configurations, and/or combinations thereof.

The reader device 14 may include one more suitable components for reading and/or analyzing the reactant array 18. Example suitable components of the reader device 14 include, but are not limited to, an imaging system 16, light collection components, one or more light or image sensors 28, one or more windows 30, one or more substrate detectors, one or more controllers 32, one or more light sources or illumination components, one or more sets of lenses, one or more motors, one or more pumps, one or more buttons, one or more user interfaces, one or more displays, and/or other suitable components. In some examples, the reader device 14 may be a bench top device or a handheld device. In some cases, the reader device 14 may be isolated from an area of the substrate 12 that is exposed to a fluid of interest and may be configured for reuse.

The reader device 14 may be powered with any suitable power source. Example suitable power sources for powering the reader device 14 include, but are not limited to, battery power in the reader device 14, solar power at the reader device 14, wall or line power, and/or other suitable power sources. In some examples, to facilitate forming the reader device 14 with a handheld configuration, the reader device 14 may be powered by one or more batteries and/or by solar power.

The light or image sensor 28 of the imaging system 16 may be and/or may include one or more light collectors of any suitable type. Example suitable types of light collectors may include, but are not limited to, a light sensor, an imaging sensor, an n-dimensional sensor array (e.g., where “n” equals 1, 2, etc.), a one-dimensional sensor array, a linear two-dimensional (2D) light detector array image sensor, light detector array image sensor, a photodiode array, a spectrometer, a refractometer, a charge-coupled device (CCD) image sensor, complementary metal-oxide semiconductor (CMOS) image sensor, a fixed imaging sensor, contact image sensor (CIS), color contact image sensor (CCIS), a monochrome image sensor, a camera, other suitable light collectors, and/or combinations of light collectors. In one example, the light collector may include or may be a spectrometer configured to measure photons collected from (e.g., reflected, transmitted, and/or otherwise received from) the reactant array. Utilizing a spectrometer may facilitate sensing wavelengths of light with high resolution in the nanometer range and may provide a continuous set of data over the wavelength range, which allows for a sensitive analysis of the data to identify components of a fluid to which the reactant array 18 was exposed relative to when other light collectors are used. In another example, the light collector may include a 2D pixel array image sensor configured to record multiple spatial interferograms in a pixel array direction of an interferogram representing a Fourier transform of the reactant array 18, which may provide sufficient sensitivity, while being compact and cost-effective. In another example, the light collector may include a fixed imaging sensor to provide a facilitate compact form of the reader device 14.

Although not depicted in FIG. 1, the reader device 14 may include one or more substrate detectors. In some examples, the substrate detector may be configured to detect when the substrate 12 is proximate and/or received in the reader device 14. In one example, the substrate detector may be a pin or button or other component, where the pin or button or other component physically or mechanically engages the substrate 12 as the substrate 12 is inserted into or positioned at the reader device 14 and in response, the pin or button or other component adjusts and provides a mechanical and/or electrical (e.g., completes a circuit, etc.) indication that the substrate 12 has been received. Alternatively or additionally, the substrate detector may be an electronic sensor or detector and/or other suitable type of detector that may provide an indication to the reader device 14 indicating that the substrate 12 is proximate and/or has or has not been received in the reader device 14 (e.g., has or has not been properly received in the reader device 14). In some cases, the electronic sensor or detector may sense a signal from the substrate 12 (e.g., an RF signal), sense the substrate 12 breaking a circuit of the reader device 14, completing a circuit of the reader device 14 and/or the substrate 12, and/or sense a presence of the substrate 12 in one or more other suitable manners.

In addition to or as an alternative to the substrate detector, the reader device 14 may include a single-use component. The single-use component of the reader device 14 may include a feature configured to electrically, mechanically, or electrically and mechanically modify the substrate 12 such that the substrate 12 will not be used more than once by the reader device 14 (e.g., in more than one test by the reader device 14). Example single use components include, but are not limited to, a component configured to write to an RFID tag of the substrate 12, a component configured to mechanically alter the substrate 12 to prevent recoupling of the substrate 12 after the substrate 12 has been removed from the reader device 14, a camera configured to read a code (e.g., a bar code, QR code, alphanumerical code, color code, etc.) on a surface of the substrate 12 or an RFID reader configured to read a code from an RFID of the substrate 12 and add the code or other identifying material to a list of used substrates 12 in memory of the reader device 14 and/or in communication with the reader device 14.

The controller 32 of the reader device 14 may be configured to control operations of the reader device 14 in response to receiving one or more control signals and/or use inputs. The controller 32 may store captured data at the reader device 14 and/or send data to a remote storage component for storage and the controller 32 may use stored captured data to analyze the reactant array 18. Further the controller 32, may be implemented entirely on the reader device 14, partially on the reader device 14 and partially remotely, and/or entirely remotely (e.g., on a server or other suitable computing device, on the substrate 12, on a user's mobile device, etc.)

The controller 32 of the reader device 14 may be coupled to one or more other electronic components of the system 10. For example, the controller 32 may be communicatively coupled with one or more of the illumination components, when included, the light or image sensor 28, the cartridge detector, the single-use component, and/or one or more other suitable components of the system 10 and/or remote components (e.g., servers, mobile devices, etc.) that may or may not be part of the system 10. In some examples, the controller 32 may be configured to receive an indication to initiate a fluid test (e.g., from a user via a user interface of or in communication with the controller 32, from the cartridge detector, etc.) and send coordinated control signals to one or more electronic components of the system 10.

The controller 32 may be configured to identify or may facilitate identifying a component of fluid in contact with the reactant array 18 and/or a condition of a target area based on measured (e.g., sensed and/or calculated) levels of light (e.g., interferograms, images, reflectance, etc.) or changes in light sensed or collected from the reactant array 18 with the light or image sensor 28. In some examples, the controller 32 may be configured to identify a component of fluid in contact with the reactant array 18 and/or a condition at or of the target area based on one or more of a timing of levels of light from the reactant array 18, an absolute change between a light from the reactant array 18 at a time of or prior exposure to a fluid of interest add at a predetermined time of or after initially exposing the reactant array to the fluid of interest, and light from the reactant array 18 relative to predetermined or expected light from the reactant array 18. The controller 32 may be configured to identify the component of the fluid in contact with the reactant array 18 and/or a condition at a location from which the fluid of interest was taken (e.g., a wound, pollen from a flower, an infection, an exhalation from a subject, a sweat gland, etc.) based on light from the reactant array 18 that is received at the light or image sensor 28 in one or more additional or alternative manners.

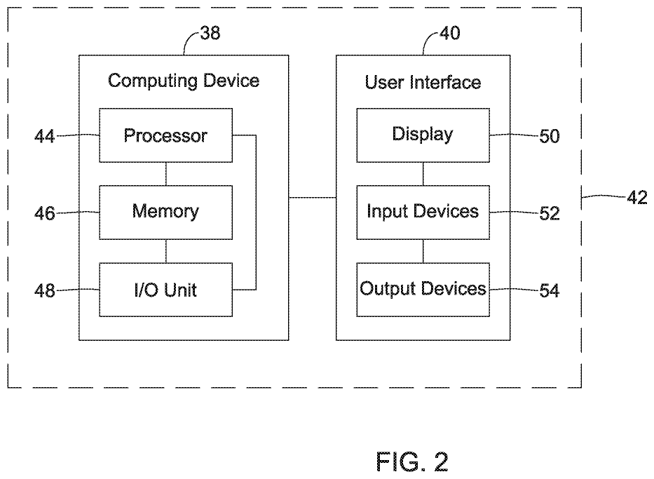

The controller 32 and/or other components of the system 10 may be or may include one or more computing devices including or coupled with one or more user interfaces. FIG. 2 depicts a schematic diagram of an illustrative computing device 38 and a user interface 40, where the computing device 38 and/or the user interface 40 may be entirely or partially housed in one or more housings 42 (e.g., a housing which may or may not house other components of the system 10). The housing 42 may be an optional component, as represented by the broken lines defining the housing 42 depicted in FIG. 2. Although various components are depicted as being included in the computing device 38 and the user interface 40, one more of the depicted components may be omitted and/or one or more additional or alternative components may be utilized.

The computing device 38 may be any suitable computing device configured to process data of or for the system 10 and may be configured to facilitate operation of the system 10. The computing device 38, in some cases, may be configured to control operation of the system 10 by establishing and/or outputting control signals to the light or image sensor 28 and/or other electronic components of the system 10 to run a test on fluid from a target area that interacts with the reactant array 18 and/or monitor results of a test. In some examples, the computing device 38 may be part of the controller 32 and may communicate with other components over a wired or wireless connection, but other suitable configurations are contemplated. When the computing device 38, or at least a part of the computing device 38, is a component separate from a structure of the controller 32, the computing device 38 may communicate with electronic components of the system 10 over one or more wired or wireless connections or networks (e.g., LANs and/or WANs). In some cases, the computing device 38 may communicate with a remote server or other suitable computing device.

The illustrative computing device 38 may include, among other suitable components, one or more processors 44, memory 46, and/or one or more input/output (I/O) units 48. Example other suitable components of the computing device 38 that are not specifically depicted in FIG. 2 may include, but are not limited to, communication components, a touch screen, selectable buttons, and/or other suitable components of a computing device. As discussed, one or more components of the computing device 38 may be separate from the controller 32 and/or incorporated into the components of the controller 32.

The processor 44 of the computing device 38 may include a single processor or more than one processor working individually or with one another. The processor 44 may be configured to receive and execute instructions, including instructions that may be loaded into the memory 46 and/or other suitable memory. Example components of the processor 44 may include, but are not limited to, central processing units, microprocessors, microcontrollers, multi-core processors, graphical processing units, digital signal processors, application specific integrated circuits (ASICs), artificial intelligence accelerators, field programmable gate arrays (FPGAs), discrete circuitry, and/or other suitable types of data processing devices.

The memory 46 of the computing device 38 may include a single memory component or more than one memory component each working individually or with one another. Example types of memory 46 may include random access memory (RAM), EEPROM, flash, suitable volatile storage devices, suitable non-volatile storage devices, persistent memory (e.g., read only memory (ROM), hard drive, flash memory, optical disc memory, and/or other suitable persistent memory) and/or other suitable types of memory. The memory 46 may be or may include a transitory or a non-transitory computer readable medium. The memory 46 may include instructions stored in a transitory state and/or a non-transitory state on a computer readable medium that may be executable by the processor 44 to cause the processor 44 to perform one or more of the methods and/or techniques described herein. Further, in some cases, the memory 46 and/or other suitable memory may store data received from the light or image sensor 28 and/or other components of or in communication with the system 10.

The I/O units 48 of the computing device 38 may include a single I/O component or more than one I/O component each working individually or with one another. Example I/O units 48 may be or may include any suitable types of communication hardware and/or software including, but not limited to, communication components or ports configured to communicate with electronic components of the system 10 and/or with other suitable computing devices or systems. Example types of I/O units 48 may include, but are not limited to, wired communication components (e.g., HDMI components, Ethernet components, VGA components, serial communication components, parallel communication components, component video ports, S-video components, composite audio/video components, DVI components, USB components, optical communication components, and/or other suitable wired communication components), wireless communication components (e.g., radio frequency (RF) components, Low-Energy BLUETOOTH protocol components, BLUETOOTH protocol components, Near-Field Communication (NFC) protocol components, WI-FI protocol components, optical communication components, ZIGBEE protocol components, and/or other suitable wireless communication components), and/or other suitable I/O units 48.

The user interface 40 may be configured to communicate with the computing device 38 via one or more wired or wireless connections. The user interface 40 may include, among other components, one or more display devices 50, one or more input devices 52, one or more output devices 54, and/or one or more other suitable features. Although not depicted, the user interface 40 may include one or more indicators (e.g., light emitting diodes (LEDs), LED linear arrays, numbers, etc.) In some examples, the user interface 40 may be part of or may include the computing device 38. Alternatively or additionally, the user interface 40 may be part of a mobile device or remote computing system.

The display 50 may be any suitable display. Example suitable displays include, but are not limited to, touch screen displays, non-touch screen displays, liquid crystal display (LCD) screens, LED displays, head mounted displays, virtual reality displays, augmented reality displays, a mobile device display, and/or other suitable display types. In some examples, the display 50 may be configured to depict an image captured by the reader device 14 (e.g., captured by the light or image sensor 28). The image may be a live image and/or a photograph or image captured at a previous time. In one example, the image may be a live image of the reactant array 18. Further, the display 50 may display material other than the image including, but not limited to, instructions for testing a fluid, a test status (e.g., a progression of steps in an analysis of the reactant array 18), a system status, results of an analysis of the reactant array 18, marketing indicia, brand indicia, videos, user pictures, art work, etc.

The input device(s) 52 may be and/or may include any suitable components and/or features for receiving user input via the user interface 40. Example input device(s) 52 may include, but are not limited to, touch screens, keypads, mice, touch pads, microphones, selectable buttons, selectable knobs, optical inputs, cameras, gesture sensors, eye trackers, voice recognition controls (e.g., microphones coupled to appropriate natural language processing components) and/or other suitable input devices. In one example, the input devices 52 may include a touch screen that allows for setting set points, initiating a fluid or target area analysis test, adjusting between screens (e.g., a testing screen, a data analysis screen, a results screen, etc.), and/or allows for taking one or more other suitable actions.

The output device(s) 54 may be and/or may include any suitable components and/or features for providing information and/or data to users and/or other computing components. Example output device(s) 54 include, but are not limited to, displays, speakers, vibration systems, tactile feedback systems, optical outputs, and/or other suitable output devices.

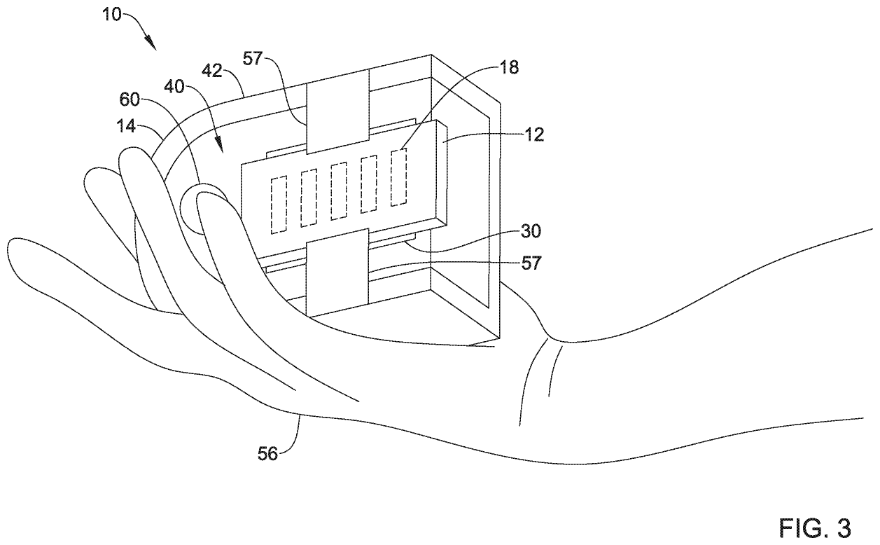

FIG. 3 schematically depicts an illustrative configuration of the system 10 configured to be held in a hand 56 of a user. Although the system 10 may take on a variety of different handheld configurations (and/or non-handheld configurations), the system 10 depicted in FIG. 3 may include the substrate 12 inserted into the reader device 14 through a holder 57 (e.g., a clip, a slot, or other suitable holder). The substrate 12 may include the reactant array 18 on a side facing the window 30. In some examples, the holder 57 may be part of the housing 42 and may be configured to position the reactant array 18 at a desired location against the window 30 and/or spaced from the window 30 (e.g., distal of an outer surface of the window 30) to facilitate imaging the reactant array with the light or image sensor 28 (not shown in FIG. 3) proximal of the window 30 and within the housing 42. When the substrate 12 and the reactant array 18 are spaced distal of the window 30, the space between the window 30 and the substrate 12 may facilitate utilizing an optical relay between the reactant array 18 and the window 30, facilitate receiving a specimen with a sample to be tested (e.g., a sample providing a fluid of interest) between the substrate 12 and the window 30, and/or the space between the window 30 and the substrate 12 may facilitate receiving other suitable components.

The user interface 40 of the reader device 14 depicted in FIG. 3 may include the display 50 (not shown in FIG. 3) and one or more buttons 60. The user interface 40 may include additional and/or alternative components or features including, but not limited to, one or more indicators (e.g., LEDs, LED linear arrays, numbers, etc.) configured to indicate (e.g., as an alert, etc.) a result of a test, a test has been initiated, a test has been completed, a user is to perform an action, an action has been completed, and/or other suitable indications. In some examples, the user interface 40 or other portion of the reader device 14 may include one or more lights or illumination sources external to the housing 42 that are configured to illuminate (e.g., selectively) the reactant array 18. Additionally or alternatively, the user interface 40 may be on or part of a remote computing device, such as a mobile device, control station, web page, mobile application, and/or other suitable remote computing device. In some examples, the user interface 40 may be entirely omitted from the reader device 14 or one or more components of the user interface 40 discussed herein may be omitted from the reader device 14.

The one or more buttons 60 may be selected by a user to cause the reader device 14 and/or the substrate 12 to take one or more actions. For example, a user may interact with the one or more buttons 60 to initiate a pump of the reader device 14 and/or of the substrate 12, power on and/or off the reader device 14, initiate a motor of the reader device 14, initiate an analysis of the reactant array 18, initiate the light or image sensor 28 to take an image or capture light, eject the substrate 12, mark the substrate 12 used, initiate the display 50, and/or to cause the reader device 14 and/or the substrate 12 to take one or more other suitable actions.

As discussed, configuring the reader device 14 to have a small footprint (e.g., to be handheld, etc.) may be advantageous to facilitate transportation of, easy use of, or spontaneous use of the reader device 14 or system 10. To mitigate or reduce a size of the reader device 14, the reader device 14 may be configured as or to use an imaging system 16 configured as a fixed imaging system. Fixed imaging systems may be considered to be “fixed” because such imaging systems have a fixed focal point, fixed focal plane, or fixed focal length from the image sensor 28 (e.g., a focal length of the image sensor is not adjustable). When the imaging system 16 is configured as a fixed imaging system, any suitable type of fixed imaging system may be utilized including, but not limited to, a contact imaging system (CIS), which may be configured to have a small foot print (e.g., may be configured to be transported).

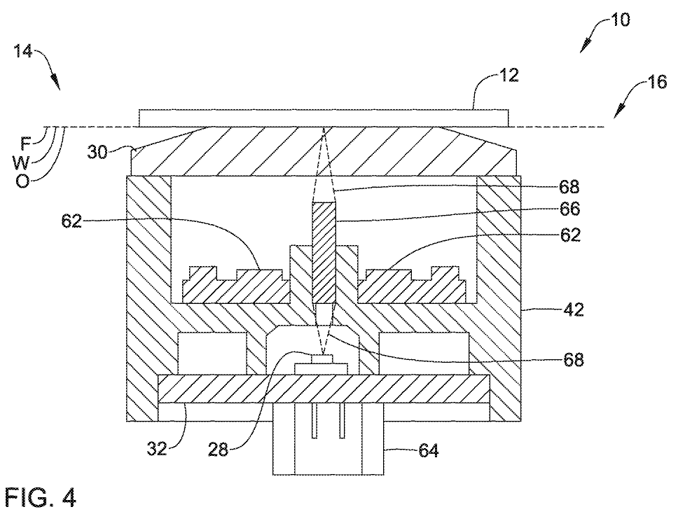

FIG. 4 depicts a schematic cross-section view of an illustrative imaging system 16 having a CIS configuration. A feature of the CIS configuration or other fixed imaging system may be its compactness that is facilitated by each sub-object to-be-imaged being imaged by a corresponding gradient or refractive index rod lens or other suitable lens component so the overall distance from the object to-be-imaged to the image sensor 28 can be very short while the amount of light collected by the optical relay system in terms of the light collection cone angle or numerical aperture (NA) can be large.

When the imaging system 16 has a CIS configuration, the imaging system 16 may have any suitable components. As depicted in FIG. 4, the reader device 14 incorporating the imaging system 16 having a CIS configuration may include one or more components including, but not limited to, the image sensor 28, the window 30 having an outer surface defining a window plane W, the controller 32, the housing 42, one or more illumination sources 62, one or more electrical and/or mechanical connectors 64, a lens array 66, and/or other suitable components. In one example, the image sensor 28 of the imaging system 16 depicted in FIG. 4 may be electrically coupled with the controller 32 and may be a one-dimensional sensor array or other suitable type of image sensor. The lens array 66 may be configured to set a fixed focal plane F of the configuration of the imaging system 16 depicted in FIG. 4 at a top or outer surface of the window 30 (e.g., at a window plane W of the window 30). The fixed focal plane F may also be or may be located at or adjacent to an object plane at which an object is to be positioned for imaging and because the fixed focal plane F is at the top or outer surface of the window 30 the object to-be-imaged may contact the window 30, hence the imaging system 16 being configured as a CIS.

The connector 64 may have any suitable configuration. In some examples, the connector 64 may be a mechanical connector, an electrical connector, a magnetic connector, and/or other suitable type of connector. In some examples, the connector 64 may be electrically coupled with the controller 32 and/or the image sensor 28 and include both of a mechanical connecting portion (e.g., a plug, a thread, a magnet, etc.) and an electrical connecting portion (e.g., a conductive prong, an inductive component, a magnet, etc.). Other suitable configurations of the connector 64 are contemplated.

The lens array 66 of the imaging system 16 having as a CIS configuration may have any suitable configuration setting the focal plane F at the top or outer surface of the window 30 (e.g., at the window plane W) and entirely or at least partially defining an imaging or optical path 68 through the window 30, through the window plane W, and to an object plane O (e.g., a plane at which the reactant arrays on the substrate 12 or other object to be imaged are located). Example suitable configurations of the lens array 66 include, but are not limited to, a rod lens array, a gradient or refractive index rod lens array, SELFOC lens array (SLA), and/or other suitable type or configuration of lens array. In one example configuration, the lens array 66 may be or may include a gradient or refractive index rod lens array or other suitable lens component.

The one or more illumination sources 62 may utilize any suitable type(s) of illuminate sources and may have any suitable configuration. Example suitable types of illumination sources 62 include, but are not limited to, light emitting diodes (LEDs), broad spectrum (visible range, for example) LEDs, discrete wavelength LEDs (400 nm, 600 nm, 700 nm, for example), illumination sources that would create fluorescence, and/or other suitable illumination sources. The illumination sources 62 may be configured within the imaging system 16 to project light onto or otherwise illuminate a target area at the focal plane F (e.g., substrate 12) using one or more of optical lenses, fiber optics, light pipes, encapsulated LEDs structures alone, and/or other suitable optical components, which may or may not be part of the illumination sources 62.

When utilizing LEDs or other suitable discretely activated light sources as part of the illumination source, the LEDs or other light sources may be configured to be turned on and off individually or collectively. Selectively turning on one or more LEDs or selectively turning off one or more LEDs (e.g., turning on an individual LED and turning all others off) may allow for choosing specific wavelengths of illumination of the reactants of the reactant array 18 that are ideally suited for sensing specific analytes that may be present in a fluid to which the reactant array 18 is exposed and may facilitate reducing optical noise (crosstalk) while maximizing a reflected/absorbed signal of a wavelength of most interest. When the substrate 12 includes the reactant array 18 that is exposed to a fluid of interest and is to be imaged for analysis, selectively turning on and/or off one or more of the LEDs or other suitable illumination sources 62 may reduce optical noise from adjacent reactants of the reactant array 18 while maximizing a wavelength signal of most-interest that is associated with a reactant in the reactant array 18 configured to be sensitive to an analyte of interest in the fluid to which the reactant array 18 was exposed, thus maximizing a signal-to-noise ratio of the image sensor 28. Such a process of turning on and/or off one or more of the LEDs or other suitable illumination sources 62 may also improve a wavelength signal from a weaker or less-sensitive reactant of the reactant array 18.

Any suitable combination of one or more illumination sources 62 may be utilized to illuminate a target. The illumination sources 62 may be interior of the housing 42 or exterior of the housing 42. In some examples, one, two, or more than two illumination sources 62 may be utilized to illuminate a target area (e.g., the focal plane F, an object plane at which an object to be imaged is located, etc.) from a viewing side of the target and/or a back side of the target (e.g., through a transparent substrate on which the target is located and/or in one or more other suitable manners). Although other illumination source configurations are contemplated, example suitable illumination source (e.g., light source) configurations are described in PCT Application No. PCT/US23/83024, entitled DEVICES, METHODS, AND SYSTEMS FOR MEASURING AND RECORDING A REACTANT ARRAY, filed on Dec. 8, 2023, which is hereby incorporated by reference in its entirety for any and all purposes and PCT Application No. PCT/US23/83063, entitled DEVICES, METHODS, AND SYSTEMS FOR MEASURING AND RECORDING A REACTANT ARRAY, filed on Dec. 8, 2023, which is hereby incorporated by reference in its entirety for any and all purposes.

As discussed, the lens array 66 of the imaging system 16 having a CIS configuration and/or other fixed imaging system configuration may be configured as a gradient or refractive index rod lens array, which may be effectively equivalent to a two-stage relay optical imaging system in that an object is firstly imaged via a first-stage relay to an intermediate image plane with the orientation of the object inverted at the intermediate image plane. Next, the intermediate plane image may become the object of the next second-stage relay that optically relays and forms a final upright image of the original object to the image sensor 28.

A two-relay optical stages may be used instead of a one-relay optical stage because when multiple gradient or refractive index rod lens arrays or other suitable optical arrays are stacked together to relay a relatively large size object to a final image plane (e.g., at the image sensor 28), the optically spatially superimposed images (e.g., formed by each gradient or refractive index rod lens) may have a right orientation (i.e. an up-right orientation) so the multiple neighboring portions can be optically stitched together with a correction orientation to reproduce the original object. Otherwise, if only one relay stage is used, the final image will have wrong neighboring portions stitched together, which produces an image with discrete inverted portions of the original object optically stitched together.

There may be many ways to form a two-stage optical relay that can result in a final up-right image. Example two-stage optical relays may include, but are not limited to, gradient index (GRIN) lenses, ball lenses, lenticular arrays, micro-lenslet arrays, gradient or refractive index rod lens arrays (e.g., a SLAs), and/or other two stage optical relays. Any final up-right image formation two-stage optical relay configurations can be applied to form a lenslet array based two-stage optical relay, optionally along with one or more light blocking components (e.g., baffles, ghost light ray baffles, etc.) (discussed below) to capture an image spaced from a focal plane of an imaging system having a CIS configuration.

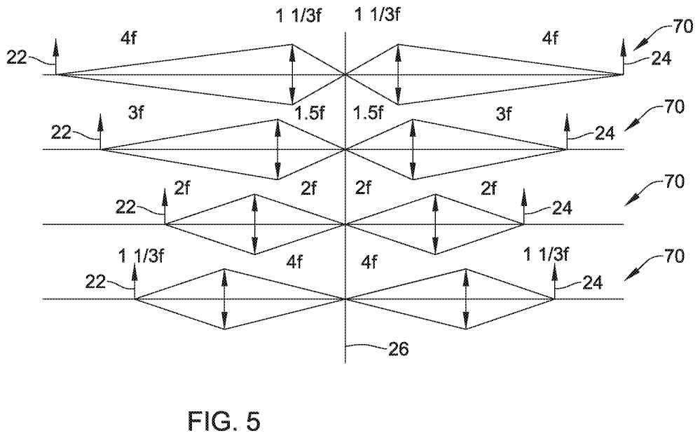

FIG. 5 schematically depicts some configurations of two-stage optical relays 70. Some of the differences between the two-stage optical relays 70 depicted in FIG. 5 relate to the focal lengths of each optical relay (e.g., from top to bottom: 4 f, 3 f, 2 f, 1 and ⅓ f) and the resulting magnification of the object at the center line 26. As depicted in FIG. 5 and represented by a height of the arrows representing objects 22 to be imaged and images 24 of the objects, the image 24 of the object 22 imaged using the two-stage optical relays 70 may be the same size as the object 22 and have the same orientation as the object 22 (e.g., an upright orientation in FIG. 5), such that an overall optical magnification of the respective two-stage optical relays 70 is one. Other suitable configurations of the optical relays 70 are contemplated, which may or may not result in upright images and/or a magnification of one relative to the imaged object. In some examples, the optical relay function of the two-stage optical relays may be in a direction of the reactant array 18 on the substrate 12 (not shown in FIG. 5) using cylinder lenslets or in a rotationally symmetric manner using spherical or aspherical lenslets. Other suitable configurations of two-stage optical relays are contemplated.

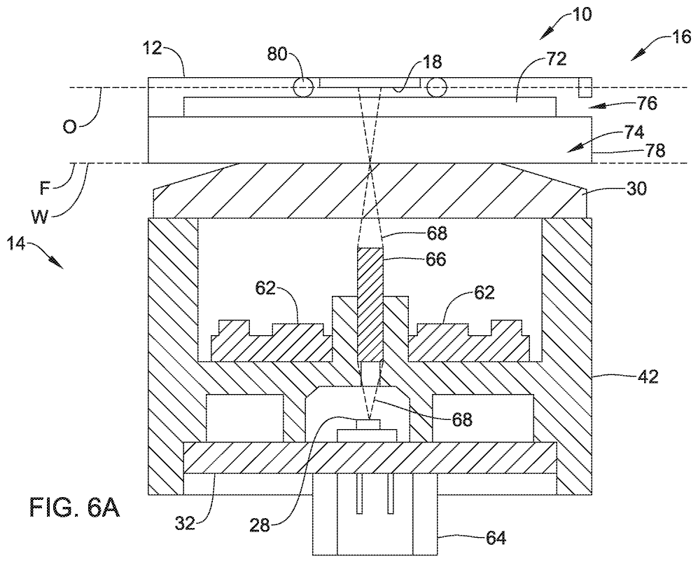

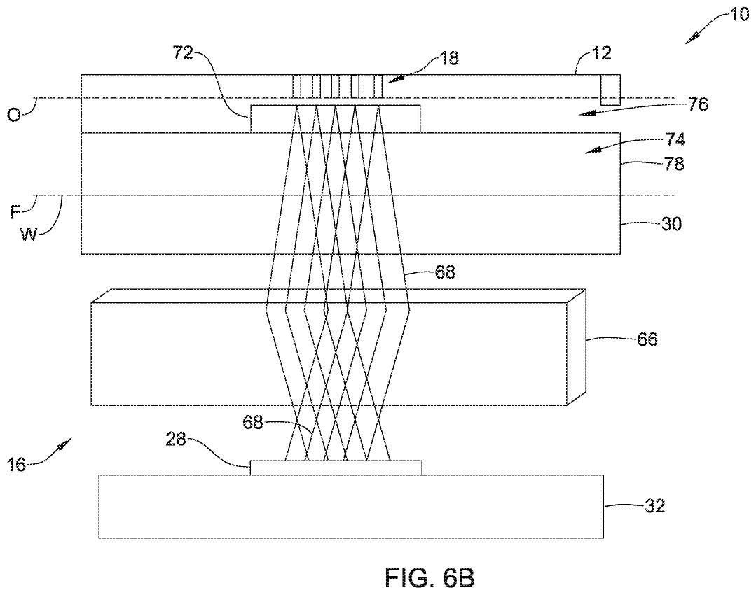

In some cases, a final image of the imaging system 16 utilizing two-stage optical relays or a lens array configuration that is equivalent to two-stage optical relays may result in lenslet pixilation of the final image. Such lenslet pixelization may be inconsequential when the imaging system 16 having a fixed imaging system configuration is used to relay the light from or image of reactants of the reactant array 18 at the focal plane F proximate to the outer surface (e.g., the window plane W) of the window 30 to the image sensor 28 of the imaging system 16. However, when analyzing the reactant array 18 with the reader device 14, there may be a need for a fluid flow space between an object plane O (e.g., a surface of the color bars of the reactant array) and the focal plane F (e.g., a contact surface at an outer surface of the window 30, along the window plane W) of the imaging system 16 having a CIS configuration CIS or other fixed imaging system configuration. When there is a spacing 74 between the object plane O and the focal plane F, as depicted for example in FIG. 6A, an image captured by the image sensor 28 of an object (e.g., the reactant array 18) at a location spaced from the focal plane F may not be suitably focused for analyzing the object imaged. In some examples, the blurriness or lack of focus of the image captured may result in cross talk of light wavelengths from the reactants of object to be imaged and reduce an effectiveness of an analysis of the captured image of the object (e.g., particularly where the captured image is already pixelated due to lenslet pixilation).

As depicted in the schematic cross-sectional view of FIG. 6A, the substrate 12 may have a cartridge configuration with the reactant array 18 thereon and facing the window 30 when the substrate 12 is at or engaging at the housing 42 or the window 30 with a spacing 74 between the object plane O at the reactant array 18 (e.g., depicted from an end view in FIG. 6A) and the focal plane F at an outer surface of the window 30 (e.g., at the window plane W). Although the substrate 12 is depicted in FIG. 6A as having a cartridge configuration, the substrate 12 may have one or more other suitable configurations described herein or otherwise and the reactant array 18 may be exposed to a fluid while at the reader device 14 or prior to being positioned at the reader device 14.

The spacing 74 between the object plane O at the reactant array 18 and the focal plane F at an outer surface of the window 30 may be any suitable distance. In some examples, the spacing 74 may span a distance in a range of 2 millimeters (mm) to 5 mm, but other suitable distances and ranges of distances are contemplated.

The substrate 12 having a cartridge configuration may include an opening 76 configured to receive the specimen 72 having a sample thereon for analysis and a standoff portion 78 configured to engage the outer surface of the window 30 (e.g., as depicted in FIG. 6A), engage the housing 42, or engage one or more other portions of the reader device 14 to ensure there is a desired spacing between imaging sensor 28 and the object plane O. In some examples, the substrate 12 may include one or more seals 80 configured to extend around the reactant array 18 and a sample on the specimen 72 to create a fluid flow space between the reactant array 18 and the specimen 72. The seal 80 may be any suitable type of seal including, but not limited to, an o-ring or other suitable seal configuration. Although the opening 76, the standoff 78, and the one or more seals 80 are depicted as being part of the substrate 12, it is contemplated that one or more of the opening 76, the standoff 78, and the seals 80 may be incorporated within the housing 42 of the reader device 14 or may be separate from the substrate 12 and the reader device 14.

The specimen 72 may be configured as a glass slide and the opening 76 may be configured to receive the glass side. Alternatively or additionally, the opening 76 may be configured to receive a fluid to be analyzed with the reactant array 18. The specimen 72 and/or the opening 76 may have other suitable configurations.

FIG. 6B is a schematic box diagram of a side view of the reader device 14 configuration depicted in FIG. 6A, with the substrate 12 configured as a cartridge having the opening 76 for receiving the specimen 72 and the standoff 78 for creating the space between the object plane O and the focal plane F at the outer surface of the window 30. Whereas the reactant array 18 is depicted from an end view in FIG. 6A, the reactant array 18 is depicted from a side view in FIG. 6B with individual reactants depicted. Some components depicted in FIG. 6A are not reproduced in FIG. 6B for clarity purposes.

As depicted in FIG. 6B, the optical paths 68 (not all optical paths 68 are labeled for clarity purposes) from individual reactants of the reactant array 18 overlap with optical paths 68 of other reactants, which may cause cross talk of light from the different reactants of the reactant array. In colorimetry, a purity of a reactant's light collected for analysis may be important for assessing changes in the light collected from the reactant and when cross talk occurs between light from reactants, the light captured by the image sensor 28 may be blended light from a plurality of reactants of the reactant array. The blending of light from a plurality of reactants of the reactant array 18 may distort a light that is associated with each reactant of the reactant array 18 and thus, reduce the accuracy or sensitivity of the analysis of a fluid or sample.

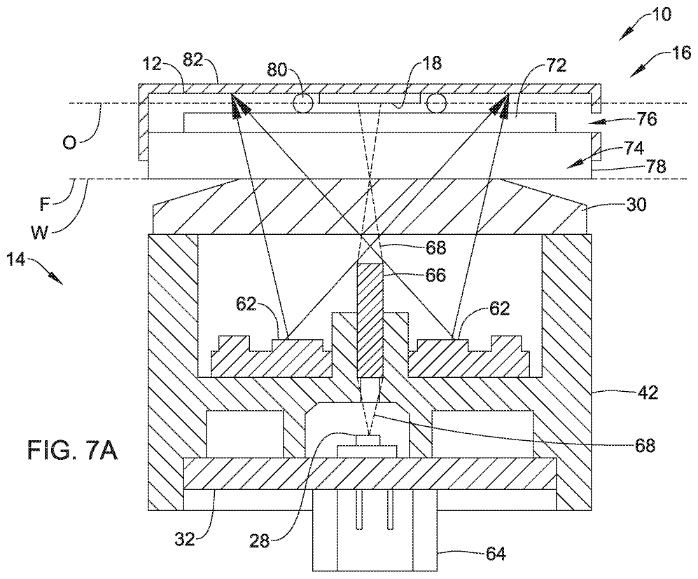

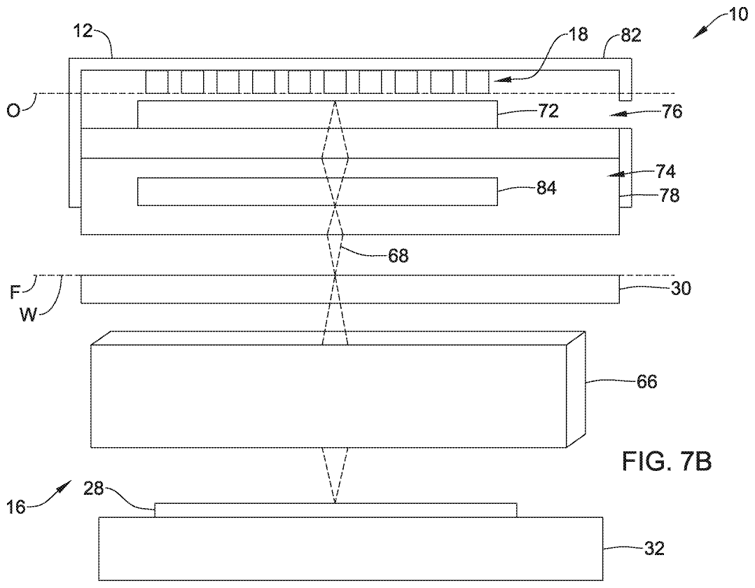

To mitigate cross talk of light from reactants proximate one another in the reactant array 18 and achieve a desired accuracy or sensitivity for detecting analytes in a fluid by analyzing images of or light from reactants of the reactant array 18, the system 10 may be configured to effectively extend the focal plane F of the image sensor 28 beyond the top surface of the window 30 to the object plane O or effectively extend the object plane O from the reactant array 18 to the top surface of the window 30, while the reader device 14 maintains a self-contained small package. In some examples, the imaging system 16 may have a CIS configuration or other suitable fixed imaging system with one or more optical relays 84 between the window 30 (e.g., the window plane W) and the reactant array 18 or other object to be imaged, as depicted for example in FIGS. 7A and 7B.

Utilizing one or more optical relays 84 between the window 30 and the object to be imaged may allow for using the reader device 14 in a variety of applications where a compact size imaging system solution is needed and an object to be imaged is to be spaced from the window 30 (e.g., for ease of use, to create space for providing the specimen 72 to a location proximate the reactant array 18, to create space for flowing fluid to be sensed to the reactant array 18, etc.) In one example, the one or more optical relays 84 between the window 30 and the object plane O at the reactant array 18 may relay light from or an image of the reactant array 18 onto the focal plane F (e.g., which may be located at the window plane W of the window 30) configured by the lens array 66 to be at the outer surface of the window 30 via an eight focal length or 8-f optical relay and/or other suitable optical relay. In the example, the 8-f optical relay and/or other suitable optical relay may redirect light from the illumination sources 62 onto the object plane O at or proximate the reactant array 18.

By designing the optical relay 84 to be located between the window 30 and the reactant array 18, the light from or image of the reactant array 18 spaced from the window 30 can be relayed to the image sensor 28 with a relatively sharp focus in at least the reactant array direction. Additional enhancement for color sharpness could be achieved with one or more filters (e.g., doping the surfaces, additional optics, etc.) at the ends of the optical relay to eliminate unwanted spectra (e.g., bandpass, polarizing, filters, etc.). Additionally or alternatively, a light blocking component 82 or array (e.g., a baffle array, etc.) may be used to block undesired light rays from reaching reactants of the reactant array 18 such that the cross talk of light from adjacent reactants is substantially suppressed. Additionally or alternatively, a prism array can also be arranged around the optical relay to redirect illumination light to the reactants of the reactant array 18 from the illumination sources 62 inside of the housing 42 or external of the housing 42.

As depicted in the schematic cross-sectional view of FIG. 7A, the substrate 12 may have a cartridge configuration with the reactant array 18 thereon and facing the window 30 when the substrate 12 is at the housing 42 or window 30 with a spacing 74 between the object plane O at the reactant array 18 (e.g., depicted from an end view in FIG. 6A) and the focal plane F at an outer surface of the window 30. The substrate 12 having a cartridge configuration may include the opening 76 configured to receive the specimen 72 having a sample thereon for analysis and the standoff portion 78 configured to engage the outer surface of the window 30 (e.g., as depicted in FIG. 7A), engage the housing 42, or engage one or more other portions of the reader device 14 to ensure a desired spacing is achieved between the image sensor 28 and the object plane O. In some examples, the substrate 12 may include one or more optical relays 84 located between the reactant array 18 and the window 30 to focus light from or an image of the reactant array 18 on the outer surface of the window 30 (e.g., at the focal plane F) to facilitate capturing an in-focus image of or light from the reactant array 18. Further, as depicted in FIG. 7A, the substrate 12 may include the light blocking component 82 (e.g., a baffle, a baffle array, and/or other suitable baffle) configured to block light from exterior of the reader device 14 and not intended to reach the reactant array 18 from reaching the reactant array 18. Although the opening 76, the standoff 78, the one or more optical relays 84, and the one or more light blocking components 82 are depicted as being part of the substrate 12, it is contemplated that one or more of the opening 76, the standoff 78, the one or more optical relays 84, and the one or more light blocking components 82 may be incorporated into the housing 42 of the reader device 14 or may be separate from the substrate 12 and a component within or at the housing 42.

FIG. 7B is a schematic box diagram of a side view of the configuration of the reader device 14 depicted in FIG. 7A, with the substrate 12 configured as a cartridge and having the opening 76 for receiving the specimen 72, the standoff 78 for creating the space between the object plane O and the focal plane F at the outer surface of the window 30, the one or more light blocking components 82, and the one or more optical relays 84. For clarity purposes, some components depicted in FIG. 7A are not reproduced in FIG. 7B and FIG. 7B depicts only a single optical path 68 between a single reactant and the image sensor 28, though each reactant may have an optical path 68 extending to the image sensor 28. As depicted in FIG. 7B the optical paths 68 from individual reactants of the reactant array 18 may be focused by the one or more optical relays 84 onto the focal plane F at the outer surface of the window 30, which allows the image sensor 28 to capture light from or an image of the reactant array 18 that is focused and does not include or mitigates cross talk (e.g., overlap) of light from reactants of the reactant array 18.

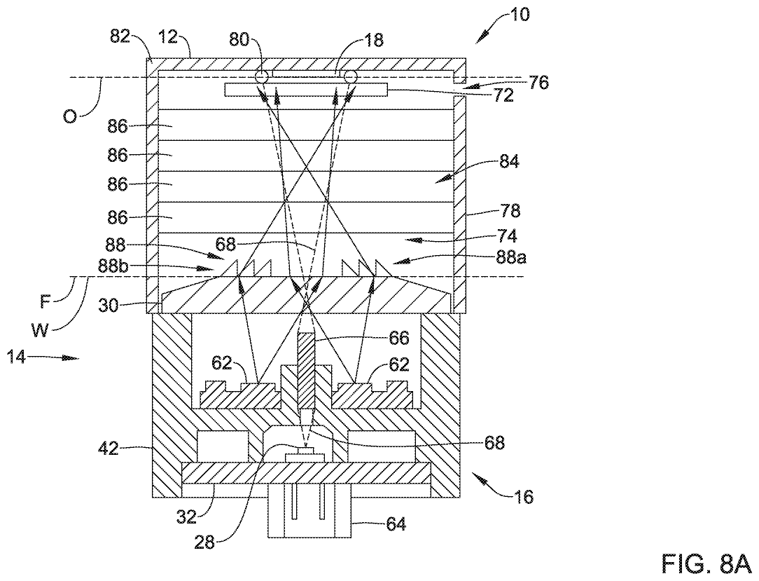

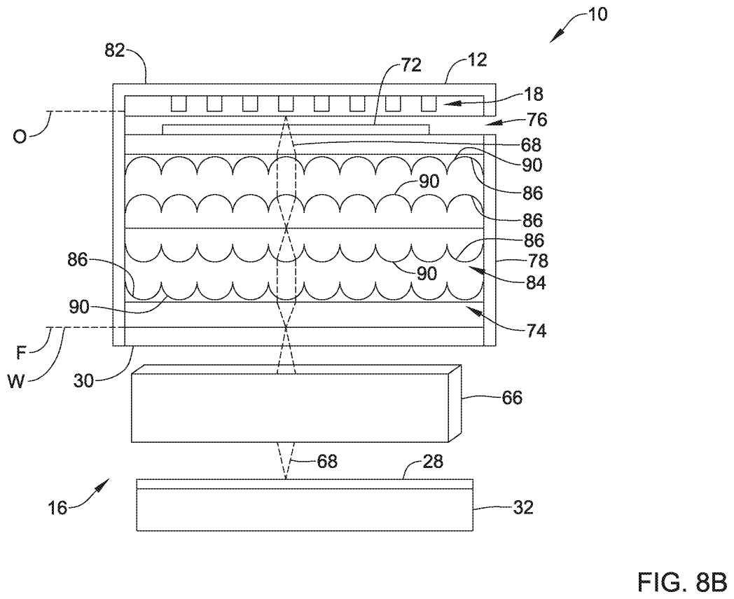

The one or more optical relays 84 may have any suitable configuration. Example suitable configurations of the optical relays 84 may include, but are not limited to, two-stage optical relays, gradient index (GRIN) lenses, ball lenses, lenticular arrays, micro-lenslet arrays, cylindrical lenslet arrays, gradient or refractive index rod lens arrays (e.g., a SLAs), and/or other optical relays. FIGS. 8A-11 depicts systems 10 utilizing illustrative configurations of the optical relays 84.

As depicted in the schematic cross-sectional view of FIG. 8A, the substrate 12 may have a cartridge configuration with the reactant array 18 thereon and facing the window 30 when the substrate 12 is at the housing 42 or the window 30 with a spacing 74 between the object plane O at the reactant array 18 (e.g., depicted from an end view in FIG. 6A) and the focal plane F at an outer surface of the window 30. The substrate 12 having a cartridge configuration may include the opening 76 configured to receive the specimen 72 having a sample thereon for analysis and the standoff portion 78 (e.g., which may be defined by the light blocking component 82) configured to engage the outer surface of the window 30, engage the housing 42 (e.g., as depicted in FIG. 8A), or engage one or more other portions of the reader device 14 to ensure a desired spacing between the image sensor 28 and the object plane O. In some examples, the substrate 12 may include one or more optical relays 84 located between the reactant array 18 and the window 30 to focus light from or an image of the reactant array 18 on the outer surface of the window 30 (e.g., at the focal plane F) to facilitate capturing an in-focus image or light from the reactant array 18. Although the opening 76, the standoff 78, the one or more optical relays 84, and the one or more light blocking components 82 are depicted as being part of the substrate 12, it is contemplated that one or more of the opening 76, the standoff 78, the one or more optical relays 84, and the one or more light blocking components 82 may be incorporated into the housing 42 of the reader device 14 or may be separate from the substrate 12 and a component within or at the housing 42.

Although other configurations of the one or more optical relays 84 are contemplated, the one or more optical relays 84 may include one or more cylindrical lenslet arrays or lenticular arrays 86. In one example and as depicted in FIG. 8A, the one or more optical relays 84 may include four lenticular arrays 86 (e.g., four stacked lenticular arrays) configured such that the optical path 68 passes through each of the four lenticular arrays and results in a focused image of the reactant array 18 at the focal plane F at the outer surface of the window 30 or other suitable location. Other suitable configurations of the lenticular arrays are contemplated.

Cylindrical lenslet arrays or lenticular arrays 86 may be used as the optical relay 84 when there is only a need for an optical relay or focusing along the direction of the array of reactants (e.g., the side view plane as shown in FIG. 8B) because blurring along the other orthogonal direction does not cause color cross talk. Further, the image sensor 28 (e.g., a 1-dimensional image sensor array) may have long rectangular pixel sizes, which also may mitigate blurring of an image along the length direction of each pixel captured by the image sensor 28. When, however, an n-dimensional reactant array 18 is used, where n is greater than 1, the optical relay 84 may be modified to mitigate cross talk.

The reader device 14 may include one or more prism arrays 88 configured to direct (e.g., redirect) light from the illumination sources 62 (e.g., illumination sources 62 within the housing 42) to an object to be imaged, such as the reactants of the reactant array 18. In some examples, the one or more prism arrays 88 may be located on or proximate the outer surface of the window in the space between the window 30 and the bottom-most lenticular array 86. In one example, the one or more prism arrays 88 may include a first prism array 88a and a second prism array 88b spaced from the first prism array to allow the optical path 68 between the image sensor 28 and the reactants of the reactant array 18 to pass by the prism arrays 8 without interacting with the prism arrays 88.

FIG. 8B is a schematic box diagram of a side view of the configuration of the reader device 14 depicted in FIG. 8A, with the substrate 12 configured as a cartridge and having the opening 76 for receiving the specimen 72, the standoff 78 for creating the space between the object plane O and the focal plane F at the outer surface of the window 30, the one or more light blocking components 82, and the one or more optical relays 84. For clarity purposes, some components depicted in FIG. 8A are not reproduced in FIG. 8B and FIG. 8B depicts only a single optical path 68 between a single reactant and the image sensor 28, though each reactant may have an optical path 68 extending to the image sensor 28. As depicted in FIG. 8B the optical paths 68 from individual reactants of the reactant array 18 are focused by the four lenticular arrays 86 onto the focal plane F at the outer surface of the window 30, which allows the image sensor 28 to capture light from or an image of the reactant array 18 that is focused and does not include or mitigates cross talk (e.g., overlap) of light from reactants of the reactant array 18.

The four lenticular arrays 86 used in the optical relay 84 of FIGS. 8A and 8B may have any suitable configuration. In one example and as depicted for example in FIG. 8B, the two upper lenticular arrays 86 may act as a first-stage optical relay and have their respective refracting surfaces 90 facing in a distal direction toward the reactant array 18, while the two lower lenticular arrays 86 may act as a second-stage optical relay and have their refracting surfaces 90 facing in a proximal direction toward the window 30. Other suitable configurations of the lenticular arrays 86 are contemplated.

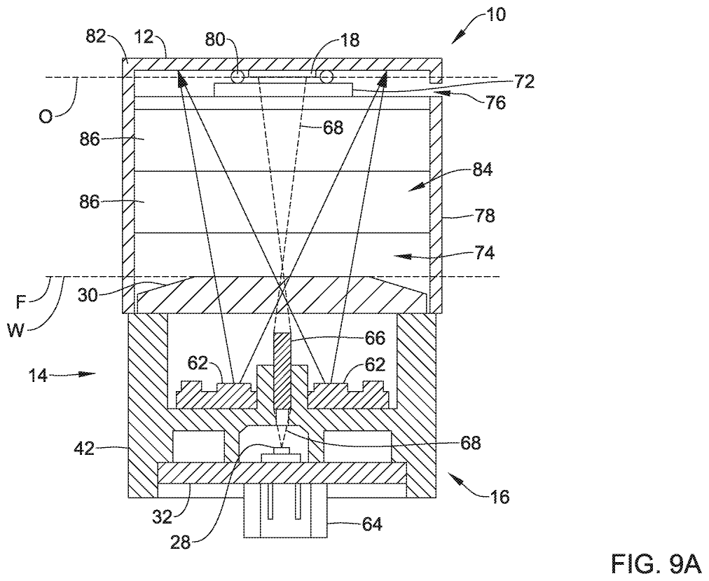

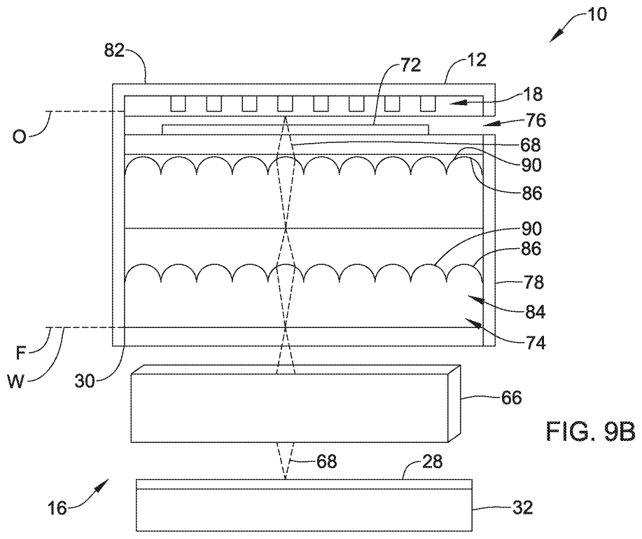

As depicted in the schematic cross-sectional view of FIG. 9A, the substrate 12 may have a cartridge configuration with the reactant array 18 thereon and facing the window 30 when the substrate 12 is at the housing 42 or window 30 with a spacing 74 between the object plane O at the reactant array 18 (e.g., depicted from an end view in FIG. 6A) and the focal plane F at an outer surface of the window 30. The substrate 12 having a cartridge configuration may include the opening 76 configured to receive the specimen 72 having a sample thereon for analysis and the standoff portion 78 (e.g., which may be defined by the light blocking component 82) configured to engage the outer surface of the window 30, engage the housing 42 (e.g., as depicted in FIG. 9A), or engage one or more other portions of the reader device 14 to ensure a desired spacing between imaging sensor 28 and the object plane O. In some examples, the substrate 12 may include one or more optical relays 84 located between the reactant array 18 and the window 30 to focus light from or an image of the reactant array 18 on the outer surface of the window 30 (e.g., at the focal plane F) to facilitate capturing an in-focus image or light from the reactant array 18. Although the opening 76, the standoff 78, the one or more optical relays 84, and the one or more light blocking components 82 are depicted as being part of the substrate 12, it is contemplated that one or more of the opening 76, the standoff 78, the one or more optical relays 84, and the one or more light blocking components 82 may be incorporated into the housing 42 of the reader device 14 or may be separate from the substrate 12 and a component within or at the housing 42.

Although other configurations of the one or more optical relays 84 are contemplated, the one or more optical relays 84 may include two lenticular arrays 86 configured such that the optical path 68 passes through each of the two lenticular arrays and results in a focused image of the reactant array 18 at the focal plane F at the outer surface of the window 30. Each lenticular array 86 may act in a direction of the reactants of the reactant array 18 as a one-to-one optical magnification relay with an inverted image. Other suitable configurations of the optical relays 84 are contemplated.

In some configurations of the reader device, the light from the illumination sources 62 with the housing 42 may be directly provided to the reactants of the reactant array through the optical relay, as depicted for example in FIG. 9A. Alternatively or additionally, the reader device 14 may include one or more prism arrays 88 (not shown in FIG. 9A), which may be configured similar to as depicted in FIG. 8A and/or configured in one or more other suitable manners.

FIG. 9B is a schematic box diagram of a side view of the configuration of the reader device 14 depicted in FIG. 9A, with the substrate 12 configured as a cartridge and having the opening 76 for receiving the specimen 72, the standoff 78 for creating the space between the object plane O and the focal plane F at the outer surface of the window 30, the one or more light blocking components 82, and the one or more optical relays 84. For clarity purposes, some components depicted in FIG. 9A are not reproduced in FIG. 9B and FIG. 9B depicts only a single optical path 68 between a single reactant and the image sensor 28, though each reactant may have an optical path 68 extending to the image sensor 28. As depicted in FIG. 9B the optical paths 68 from individual reactants of the reactant array 18 are focused by the two lenticular arrays 86 onto the focal plane F at the outer surface of the window 30, which allows the image sensor 28 to capture light from or an image of the reactant array 18 that is focused and does not include or mitigates cross talk (e.g., overlap) of light from reactants of the reactant array 18.

The two lenticular arrays 86 used in the optical relay 84 of FIGS. 9A and 9B may have any suitable configuration. In some examples and as depicted for example in FIG. 9B, each of the lenticular arrays 86 may act in the direction of the reactants of the reactant array 18 as one-to-one magnification relay with an inverted image. In some examples, the upper lenticular array 86 may act as a first-stage optical relay and have its refracting surface 90 facing in a distal direction toward the reactant array 18 and the lower lenticular array 86 may act as a second-stage optical relay and have its refracting surfaces 90 facing in the distal direction toward the reactant array 18. Other suitable configurations of the lenticular arrays 86 are contemplated.

A potential issue related to using a cylindrical lenslet arrays or lenticular arrays to optically relay an object to an image, or imaging an object in general, is that there can be ghost images (e.g., images of less intensity than an intensity of an image intended to be captured) being formed and relayed to the focal plane F and/or the image sensor 28, where the ghost images may cause a ghost-color cross talk. To suppress such ghost images, a light baffle or slit array may be arranged between reactants of the reactant array 18 and the window 30, such that each reactant of the reactant array 18 is aligned with a slit opening of a slit array or other component configured to suppress the ghost images. The light baffle or slit array may be used with or without the optical relay 84 positioned between the light baffle or slit array and the window 30.

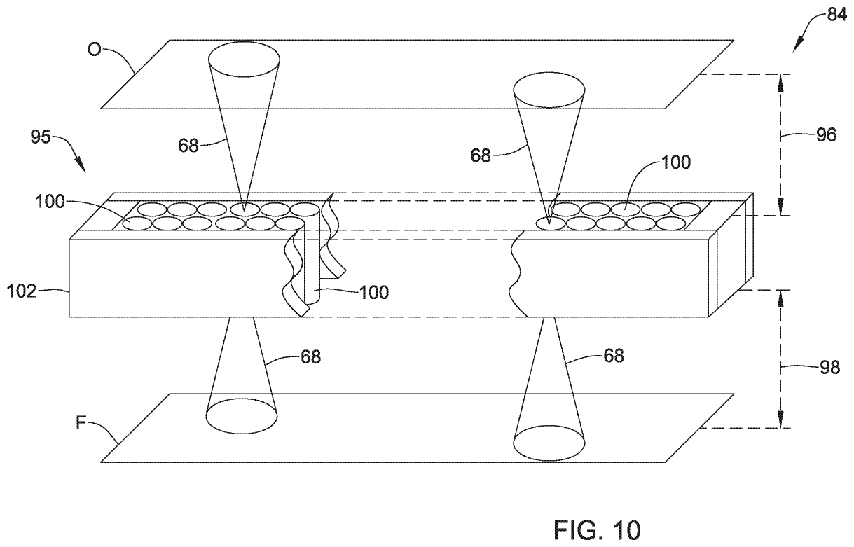

FIG. 10 depicts a schematic perspective view of an illustrative configuration of the optical relay 84. In addition to or as an alternative to using cylindrical lenslet arrays or lenticular arrays to form the optical relay 84, the optical relay 84 may include or be used with a gradient or graded refractive index rod lens array 95 (e.g., SLA). In some examples, the gradient or graded refractive index rod lens array 95 may have open object space 96 between the gradient or refractive index rod lens array 95 and the object plane O (e.g., at the reactants of the reactant array 18) and open image space 98 between the gradient or graded refractive index rod lens array 95 and the focal plane F (e.g., at an outer surface of the window 30).

The gradient or graded refractive index rod lens array 95 may have any suitable configuration. In some examples and as depicted in FIG. 10, the gradient or refractive index rod lens array 95 may include a plurality of rod lenses 100 (not all rod lenses 100 are labeled for clarity purposes) and a housing 102 configured to house the rod lenses 100 and block extraneous or unintended light from entering the rod lenses 100 or otherwise interfere with the optical paths 68 through the rod lenses 100. Each rod lens 100 may include a total internal reflection wall, which acts as a light baffle to remove ghost images passing along the optical paths 68 extending through the rod lens 100. The sidewall surfaces of the rod lenses can also be painted black or may otherwise block light with the painted black or otherwise light blocking sidewalls acting as a light baffle to remove ghost images passing along the optical paths 68 extending through the rod lens 100. The black painting approach can also be applied to the cylindrical lenslet arrays or lenticular arrays to act as a light baffle to remove ghost images. Other suitable configurations of the gradient or refractive index rod lens array 95 are contemplated.

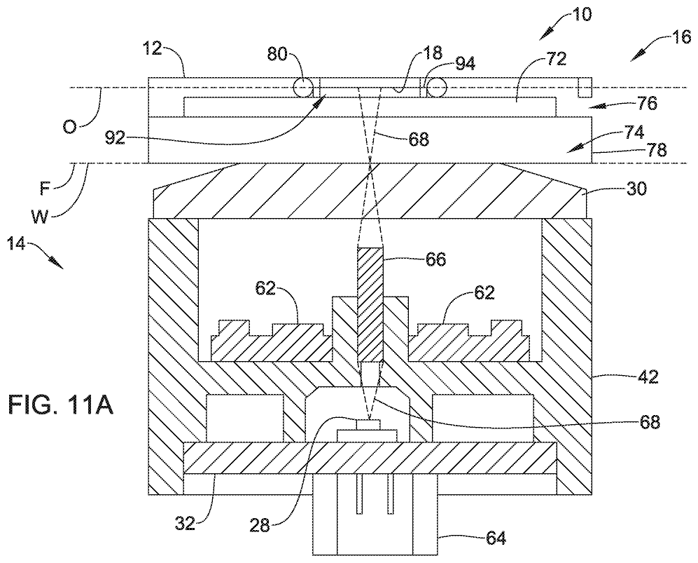

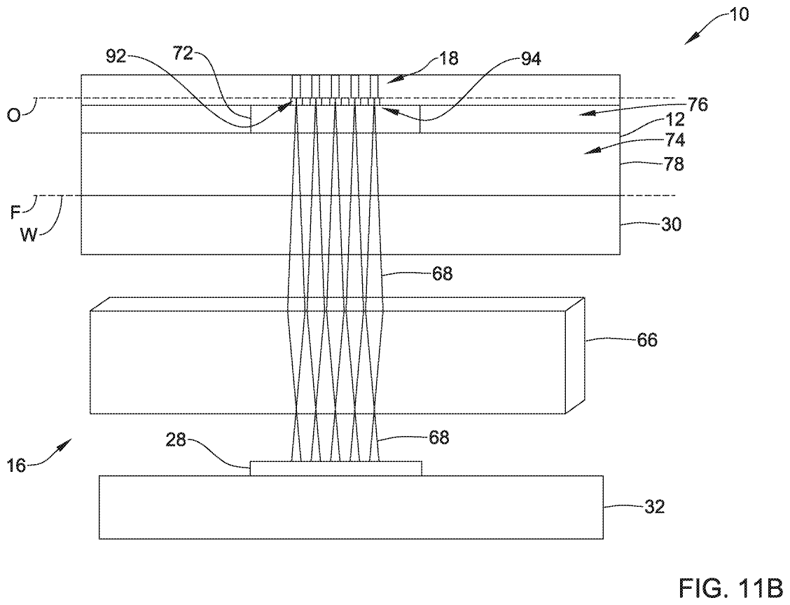

FIGS. 11A and 11B depict a configuration of the system 10 similar to the configuration of the system 10 depicted in FIGS. 6A and 6B, respectively, with a slit array 94 having a plurality of slits 92 and without the optical relay 84. Although FIGS. 11A and 11B depict the system 10 with the slit array 94 and without the optical relay 84, the slit array 94 may be used when the system 10 includes the optical relay 84 or the slit array 94 may be part of the optical relay 84.

FIG. 11A depicts a schematic cross-sectional view of the system 10 with the slit array 94 positioned between the reactant array 18 and the outer surface of the window 30. As depicted in the side view of FIG. 11B, each reactant of the reactant array 18 may be lined up with or otherwise correspond with one of the slits 92 of the slit array (not all slits 92 are labeled for clarity purposes). By aligning the reactants of the reactant array 18 with the slits 92, light from each reactant may be compartmentalized and ghost images producing cross talk and/or other cross talk may be prevented or mitigated.

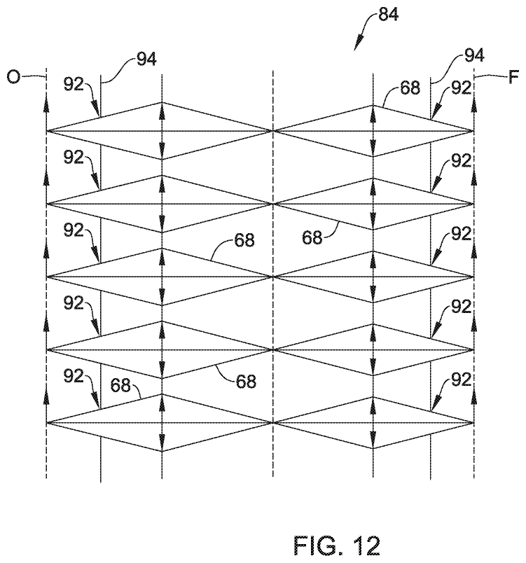

FIG. 12 schematically depicts a diagram of an optical relay 84 between the focal plane F and the object plane O. As depicted in FIG. 12, the optical relay 84 may be a two-stage optical relay and may have any suitable configuration discussed herein or otherwise. On both sides of the optical relay 84, a light blocking component or baffle, such as a slit array 94 having slits 92 configured to allow the optical path 68 to pass between the object plane O and the focal plane F.

It should be noted that in the above configurations, the optical relays 84 may have different optical imaging formation mechanisms, including, but not limited to, refraction resulting from an optical interface between two optical media of different refractive index such as cylinder or sphere lenses, refraction resulting from continuous refractive index changes such as graded refractive index rod lens, reflection resulting from the use of cylindrical or spherical mirrors, and/or other suitable optical imaging formation mechanisms.

In addition, a cross section of the configurations of the optical relays 84 may have different shapes including, but not limited to, honeycomb, circle, ellipse, square, rectangle, and/or other suitable shapes. In the case of square and honeycomb optical relays, an advantage may be that a fill factor can be very high as there is basically no space between the squares or honeycombs that is not used for refracting light. In square or honeycomb optical relays, roller made thin square or honeycomb shaped Fresnel lenslet array sheets can be used to make the optical relay 84 (e.g., a two-stage optical relay 84 or other suitable optical relay 84).

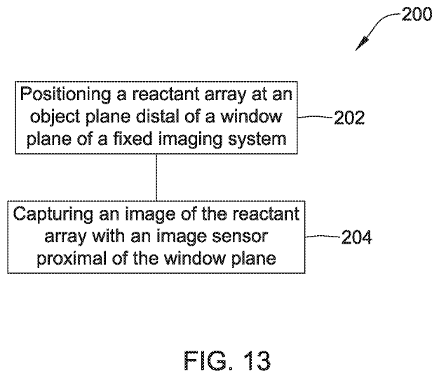

FIG. 13 depicts a schematic box diagram of an illustrative method 200 for analyzing a reactant array using a fixed imaging system. The reactant array may be analyzed for detection of analytes of interest in a fluid exposed to a sample (e.g., via a specimen or direct exposure to the sample) or for other suitable purposes. Color changes or other changes in the reactant array between two or more of before, during, or after exposure to the fluid or over time may be indicative of or more analytes of interest being present or not being present in the fluid.

The fixed imaging system used in the method 200 may have one of the configurations discussed herein, components of one or more of the configurations discussed herein, and/or other suitable configurations. In some examples, the fixed imaging system may have a CIS configuration with an image sensor and a window spaced (e.g., spaced distally) from the image sensor. The window may have an outer surface defining a window plane at which a focal plane of the image sensor is located.

Although the reactant array may be located at the window such that an object plane of the reactant array and the window plane or focal plane of the image sensor are co-planar, the reactant array may be positioned at a desired location spaced (e.g., spaced distally) from the window plane. Spacing the reactant array from the window plane may prevent unintended contamination of the reactant array due to interactions with the window, may allow fluid to pass between window and the reactant array, and/or may be provided for other suitable purposes.

A substrate on which the reactant array is located may have a standoff configured to engage the window, a housing, or other portion of the fixed imaging system to space the reactant array at a desired distance from the focal plane of the image sensor and the window plane. Alternatively or additionally, the standoff may be a component that is separate from the substrate and the fixed imaging system and configured to engage both of the substrate and the fixed imaging system to position the reactant array at a desired location relative to the focal plane of the image sensor. In some examples, the standoff may be a component of the fixed imaging system and configured to engage the substrate to position the reactant array at the desired location relative to the focal plane of the image sensor.

The fixed imaging system may include or be used with an optical relay configured to be positioned between the window of the fixed imaging system and a reactant array to be analyzed when the reactant array and an object plane thereof is spaced from the window plane. The optical relay and/or other suitable components may be configured to focus light from or an image of the reactant array at the window plane (e.g., at the focal plane of the image sensor). In one example configuration of the optical relays, the one or more optical relays may include a two-stage optical relay (e.g., formed with one or more cylindrical lenslet arrays, one or more lenticular arrays, one or more gradient or graded refractive index rod lenses, etc.)

The method 200 may include positioning 202 a reactant array at an object plane relative to the window plane of the fixed imaging system. The window plane may be co-planar with a focal plane of the image sensor. In some examples, the substrate on which the reactant array is located may be inserted into the housing of the fixed imaging system for positioning the reactant array at a desired location relative to window plane and the focal plane of the image sensor. In some examples, the reactant array may be positioned at a location spaced from and distal of a window plane of the fixed imaging system. The reactant array may be positioned in a spaced relationship with the window in any suitable manner. For example, inserting the substrate on which the reactant array is located into the housing may space the reactant array from the window plane or engaging the housing or other component of the fixed imaging system with a standoff of the substrate or used with the standoff may result in positioning the reactant array at the desired location relative to the window plane.

The method 200 may include capturing 204 light from or one or more images of the reactant array with the image sensor. The light from or images of the reactant array may be captured along an optical path that extends through the window and window plane of the fixed imaging system and to an object plane at which one or more reactants of the reactant array.

As the fixed imaging system may be configured to capture light or an image at the window plane at which the focal plane of the image sensor is located, the light from the reactant array or an image of the reactant array may be relayed from the object plane of the reactant array to the window plane when the reactant array is spaced distal of the window plane. In some examples, the light from or an image of the reactant array may be relayed to the window plane using one or more optical relays, as discussed herein or in other suitable manners. In one example, the optical path along which light from or the images of are captured may extend through the one or more optical relays.

The reactants of the reactant array may be illuminated with light from one or more illumination sources internal to or external of the housing of the fixed imaging system to facilitate capturing light from or images of the reactant array. Turning one or more of the illumination sources on or off while capturing the light or one or more images may facilitate identifying color changes or lack thereof when analyzing the light from or images of the reactant array after the reactant array is exposed to a fluid. In some examples, the light may be passed through one or more prisms or other suitable components configured to direct light from the illumination source(s) onto the reactants of the reactant array.

The optical components discussed herein (e.g., the relays, lenslets, rod lenses, baffles, etc.) may be separate components and/or two or more of the optical components may be integrated into a single component. The optical components discussed herein may be made and/or formed in any suitable manner. For example, one or more of the optical components discussed herein may be formed using molds, injection molding techniques, 3D printing techniques, machining techniques, and/or other suitable techniques. The optical components discussed herein may be formed from any suitable materials including, but not limited to, glass, plastics, other transparent medium with the appropriate optical properties, and/or other suitable materials.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Unless otherwise expressly stated, it is in no way intended that any method or technique set forth herein is to be construed as requiring that its steps be performed in a specific order. This holds for any possible non-express basis for interpretation, including matters of logic with respect to arrangement of steps or operational flow, plain meaning derived from grammatical organization or punctuation, and the number or type of embodiments described in the specification.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment being used in other embodiments. The invention's scope is, of course, defined in the language in which the appended claims are expressed.

The follow references may describe examples of one or more features discussed herein: PCT Application No. PCT/US23/83068, entitled DEVICES, METHODS, AND SYSTEMS FOR MEASURING AND RECORDING A REACTANT ARRAY, filed on Dec. 8, 2023, which is hereby incorporated by reference in its entirety for any and all purposes; PCT Application No. PCT/US23/83073, entitled DEVICES, METHODS, AND SYSTEMS FOR MEASURING AND RECORDING A REACTANT ARRAY, filed on Dec. 8, 2023, which is hereby incorporated by reference in its entirety for any and all purposes; PCT Application No. PCT/US23/83104, entitled DEVICES, METHODS, AND SYSTEMS FOR MEASURING AND RECORDING A REACTANT ARRAY, filed on Dec. 8, 2023, which is hereby incorporated by reference in its entirety for any and all purposes.

What is claimed is:

1. A system comprising:
a fixed imaging system having a window defining a window plane and an image sensor proximal of the window plane; and
an optical relay positioned between the window plane and an object plane,
wherein the fixed imaging system is configured to capture an image of an object at the object plane along an optical path through the window plane and the optical relay.

2. The system of claim 1, wherein the optical relay is configured to relay the image of the object at the object plane to the window plane.

3. The system of claim 1, wherein the optical relay comprises one or more lenticular arrays configured to relay the image of the object to the window plane.

4. The system of claim 3, wherein the one or more lenticular arrays comprises four stacked lenticular arrays forming a two-stage optical relay.

5. The system of claim 3, wherein the one or more lenticular arrays comprise:
two upper lenticular arrays having refracting surfaces facing in a distal direction, toward the object plane; and
two lower lenticular arrays having refracting surfaces facing in a proximal direction, toward the window plane.

6. The system claim 1, further comprising a prism array configured to redirect illumination light onto the object.

7. The system of claim 1, further comprising:
a slit array positioned between the window and the object plane.

8. The system of claim 1, wherein the optical relay comprises a gradient or graded refractive index rod lens array.

9. The system of claim 1, wherein the window and the image sensor are part of a contact imaging system.

10. The system of claim 1, wherein the image sensor comprises a photodiode array.

11. A system comprising:
a substrate comprising a reactant array;
a fixed imaging system having a window defining a window plane and an image sensor proximal of the window plane; and
a housing configured to receive the substrate and position the reactant array at an object plane distal of the window plane, and
wherein the fixed imaging system is configured to image the reactant array.

12. The system of claim 11, wherein the reactant array is a colorimetric sensor array.

13. The system of claim 11, wherein the fixed imaging system comprises one or more illumination sources configured to illuminate the reactant array.

14. The system of claim 11, further comprising an optical relay positioned between the window plane and an object plane located at the reactant array.

15. A method comprising:
positioning a reactant array at an object plane spaced from and distal of a window plane of a fixed imaging system, the fixed imaging system comprises an image sensor proximal of the window plane; and
capturing an image of the reactant array with the image sensor along an optical path extending through the window plane and to the object plane.

16. The method of claim 15, further comprising:
illuminating the reactant array with illumination light while imaging the reactant array.

17. The method of claim 16, further comprising:
redirecting the illumination light using a prism array.

18. The method of claim 16, further comprising:
relaying the image of the reactant array through an optical relay positioned between the window plane and the object plane.

19. The method of claim 18, wherein the optical relay comprises a plurality of lenticular arrays or gradient/graded refractive index rod lens arrays configured to form a two-stage optical relay.

20. The method of claim 16, wherein positioning the reactant array at the object plane comprises inserting a substrate comprising the reactant array in a housing.
